(19) United States
(12) Patent Application Publication
(10) Pub. No.: US 2018/0362014 A1
(43) Pub. Date: Dec. 20, 2018

(54) Adaptive power supply for electric cars

(71) Applicant: A Truly Electric Car Company, Millbrae, CA (US)

(72) Inventors: Edward Gordon Durney, Millbrae, CA (US); Kevin Durney, Millbrae, CA (US)

(21) Appl. No.: 15/628,585

(22) Filed: Jun. 20, 2017

(51) Int. Cl. B60W 20/10; B60K 6/46; B60K 6/28; B60K 6/40; B60K 6/24; B60K 6/26; B60W 10/06; B60W 10/08; B60W 10/26; B60W 30/18; B60W 30/188; F02D 41/00; F02D 15/00; F02D 13/02; F02D 9/02; B60L 11/12; H02P 4/00; H02P 3/14

(52) U.S. Cl. CPC B60W 20/10; B60W 2540/00; B60K 6/28; B60K 6/40; B60K 6/24; B60K 6/26; B60W 10/06; B60W 10/08; B60W 10/26; B60W 30/18127; B60W 30/188; F02D 41/0087; F02D 15/00; F02D 13/0215; F02D 9/02; B60L 11/12; H02P 4/00; H02P 3/14; B60Y 2200/92; B60Y 2300/18125; B60Y 2300/182; B60Y 2300/43; B60Y 2300/60; B60Y 2400/114; B60Y 2400/112; B60Y 2400/43; B60Y 2400/60; Y10S 903/93; Y10S 903/905; Y10S 903/907; Y10S 903/906; Y10S 903/951; B60W 2710/0644; B60W 2710/0666; B60W 2710/08; B60W 2710/242; B60W 2510/242; B60W 2550/00; B60K 6/46

(57) ABSTRACT

An electric car draws lots of power that needs to be on board the moving vehicle. An adaptive power supply can combine a variety of sources of electrical energy—which may include an internal combustion engine—and use those different sources to efficiently produce the electrical power required. An adaptive power supply provides optimal performance by sensing changing conditions, often hundreds of times per second, and then adapting itself to those conditions in order to optimize efficiency at each particular instant during a car's operation. Those conditions may include changes in user inputs, machine operating conditions, and machine operating parameters. Having multiple sources of electrical power allows effective control of more independent power parameters, enabling greater freedom to adapt to optimize efficiency. That gives adaptive power supplies that are cheaper, smaller, lighter, more powerful, and more efficient than conventional designs.

Electric cars run on electricity. And that is a problem.

Why? Because electricity is a tricky power source to get to a car as it travels down a road. Unlike gasoline—a primary source of power that can be easily stored in a gas tank until needed—electricity is a secondary source of power that must be used or converted and stored as soon as it is generated.

Electricity is easy enough to supply to our houses by tying into an electric grid. But our cars are moving, and that makes using a normal power plug and cord impossible. (Except as imagined humorously in the prior art shown in FIG. 1.)

There are ways to get grid electricity to a moving car, like overhead wires (using perhaps a pantograph or trolley poles) or underground wires (using perhaps an inductive coupler or other wireless power transfer). But that technology is still primitive, so for today's electric cars electricity must be stored or generated on the car, or both.

That still gives a lot of flexibility. As shown in FIG. 2, electricity can power a car by using any of a variety of fuels or converting other energy.

Still, storing electricity usually means using batteries, and they have terrible energy density. Batteries are big, heavy, expensive, temperamental, inefficient, and need to be replaced after a few years. And charging them takes time and wastes some of the electricity put into them.

Generating electricity on the car is not easy either. A gasoline engine coupled to a generator can provide a lot of power, but the engine and generator must both be big. The car's demand for electricity will vary greatly as the car speeds up and slows down, making efficiency hard to maintain.

Given the pros and cons of all sources of electricity, how can we get the needed electricity at the best possible efficiency in all conditions, even when those conditions may be rapidly changing?

Here's how.

What is an Adaptive Power Supply?

To get the needed electricity at the best possible efficiency in changing conditions, we have invented an adaptive power supply. But what is an adaptive power supply?

To give a technical definition, an adaptive power supply is one that adapts to conditions so it can continue to provide power at high efficiency. Even more precisely, an adaptive power supply dynamically responds to a change (or stimulus) that actually or potentially reduces the effectiveness of the power supply's behavior. The adaptation prevents that reduction from occurring.

What does that really mean? To understand an adaptive system, think of a cruise control. Everyone who takes lots of long drives loves cruise control. You set the speed once and do not have to worry about it from then on. The car senses its own speed, and if that speed slows down below the speed set by the driver, the car speeds itself up.

But that simple cruise control is just a control system, not an adaptive system. The driver controls the speed of the car using cruise control, and a normal cruise control simply matches the car's speed to the driver's command. A similar example of a control system would be a thermostat in a house.

Unfortunately, this cruise control has a problem—it treats the car in isolation. Driving at a fixed speed only works in traffic if every car is traveling at the same speed. As soon as the car in front slows down, cruise control loses most of its value because the driver has to react quickly so as not to plow into the other car's rear end.

To react to other cars means to react to a change or stimulus, not just respond to the driver's speed control. If the car can react to the speed of surrounding traffic, the driver does not need to. The car adapts not to changes in its own speed, but to the speed of the cars around it.

That is an adaptive cruise control. This adaptive cruise control needs sensors that can measure the distance to the car ahead as well as the rate of closure. That lets the car automatically slow down when the car ahead does; without driver intervention. It also means that if the driver changes lanes to an open one, the car automatically resumes speed.

As the adaptive cruise control system gets more information about the car and its surroundings, the more powerful it can become even though the driver need not be involved. As cars gather more and more information into their adaptive control systems, we move further down the road to completely autonomous cars.

How does this relate to our adaptive power supply? Most power supplies for electric cars are simple systems that produce the amount of power demanded by the driver. But when the power supply simply responds to driver demands, the power supply cannot adapt over time in order to produce the best results.

And that is important. In a car, the demand for electrical power often varies. Accelerating demands more electrical power. Braking demands none, and may even return power. Climbing hills demands more. Descending hills demands less.

When more than one source of electrical power is available, one source will often offer better performance and greater efficiency in meeting demand than another source. As conditions change, the better performing or most efficient choice may also change. But the driver cannot make the switch between power sources. Switching requires attention the driver cannot give, and reaction more quickly than the driver can react. The adaptation has to happen automatically.

Also, sometimes a source of electrical power can be modified to operate in different modes. As conditions change, the best operating mode for those conditions may also change. Here again, this is not really something the driver can do. The adaptation has to happen automatically.

Ideally, to optimize performance and efficiency, an electrical power supply will adapt to changing conditions to provide the needed electrical power at the highest possible performance and efficiency by considering a variety of factors and adjusting to them quickly, often on the order of hundreds of times per second.

Our invention addresses that need.

Why is an Adaptive Power Supply Important?

Cars transport people and things. That is their job. But as far as technology goes, cars are, at heart, energy conversion devices. Cars move by using mechanical power applied by tires against the road. The mechanical energy to provide that power has to come from somewhere. The question is where the energy comes from and how it is converted to mechanical power.

Energy is available in a lot of forms:
kinetic energy of a moving object
potential energy stored by an object's position in a force field (gravitational, electric or magnetic)
elastic energy stored by stretching solid objects
chemical potential energy (such as that released when a fuel burns)
radiant energy carried by light or invisible radiation
heat energy due to an object's temperature
results of mechanical work over time
nuclear potential energy
even mass itself (as Albert Einstein taught us in 1905)

The key to getting the mechanical energy to move a car is storing energy in some form that is available on the car, and then converting it to mechanical energy. That sounds simple. But it is not.

A car with a gas tank, internal combustion engine, transmission, and drive train can convert the energy in gasoline into the mechanical energy that provides comfortable transportation. Without such an “energy converter,” obtaining transportation from gasoline would be impossible.

Electric cars also convert energy, in this case electrical energy to mechanical. And since electric cars need to have some source of energy available while in motion, they need to store energy as well as convert it. There are lots of sources of electrical energy, as shown in FIG. 2. Getting that electrical energy converted and ready to use onboard the car is the problem.

In an electric car, the best possible way to provide the mechanical energy that moves the car down the road is by using a flexible, adaptable power supply that can draw on a variety of electrical energy sources in the most efficient way. Our invention does that.

In this background section, we will look at how four types of electrical power sources vary in their availability, performance and efficiency. Then later, in the detailed example section below, we will look at examples of how an adaptive power supply might draw on some or all of those four types of electrical power sources.

Internal Combustion Engine/Generator

An internal combustion engine combusts a fuel (like gasoline, diesel, or natural gas) to generate mechanical power. A generator can then convert that mechanical power to electrical power. That means that over time the chemical energy in the fuel is converted to mechanical energy, which is converted to electrical energy.

The physics of converting mechanical power to electrical power in this case are straightforward, as shown in the equations below and in FIGS. 3 and 4 (although the conversion is less than perfect, as some power is lost to friction and heat):

Power_{mechanical}=Angular Speed*Torque

Power_{electrical}=Voltage*Current

It's important too to note that any motor can act as a generator, and any generator as a motor. So the same electrical machine can convert mechanical power to electrical power and vice versa. Further, the voltage will depend on the angular speed, and the current on the torque, and vice versa, as the following statements show:

Voltage⇔Angular Speed

Current⇔Torque

So with a generator to get more voltage, you speed up the rotation of the engine, and to get more current, you increase the torque the engine produces. To get less voltage or current, you do the opposite. One can thus control the speed and torque of the engine so as to generate electricity at a desired voltage and current.

But of course, in real life the conversions are not as simple as these formulas make them seem. Looking particularly at gasoline engines, there are three problems that make it hard to control the speed and torque of gasoline engines.

First, it is hard to control the torque and speed of gasoline engines with much precision. They are designed to be controlled by a driver pushing on an accelerator and by the manual or automatic shifting of gears, both of which give only rough control of the speed and torque generated by the engine.

And while gasoline engines are pretty responsive compared to diesel engines, that's not saying much. Both are only responsive in human time frames, in other words, on the order of seconds. That's fine for driving a car, but that can give poor results when generating electricity.

Second, gasoline engines have a narrow power band, which is the range of engine speeds at which the engine can deliver torque and do it efficiently. Gears are used to spread out the power band. (Gears convert speed to torque, and vice versa, just like transformers convert voltage to current, and vice versa.)

Gears are so important for gasoline engines that in today's cars 8-speed automatic transmissions are common, 9-speeds are available, and 10-speed transmissions are in the works. Ford has even applied for a patent on an 11-speed automatic transmission. Continuously variable transmissions also give an efficiency advantage (though some disadvantages as well).

Third, gasoline engines waste power pumping air. To meet emissions standards, and to make sure the fuel burns fast enough, the air to fuel ratio is important. If exactly enough air is provided to completely burn all of the fuel, the ratio is known as the stoichiometric mixture. For gasoline, that is usually about 14.7 parts air to 1 part gasoline.

The amount of gasoline burned depends on how much torque is desired. As gasoline is injected into the cylinder, the amount of air in the cylinder needs to be adjusted to the amount of gasoline that will be injected. If less gasoline is injected, less air must be present.

A throttle is used to limit the amount of air going into the cylinder. When little gasoline will be injected, and thus little air is needed, the throttle is mostly closed, allowing only a little air to enter the cylinder. That means that the engine has to work harder to pull the air past the throttle into the cylinder, creating a partial vacuum and sapping the engine's power.

The inefficiency from pumping air can be as high as 15% in some cases. For that reason, some carmakers use cylinder deactivation, where some of the car's cylinders are not used during periods when less torque is required. That allows the throttle to be opened wider and limits the pumping losses.

As we discuss below, that same cylinder deactivation technology can be used when generating electricity to maintain peak efficiency even as speed and torque varies. And techniques other than cylinder deactivation can also be used, such as changing a cylinder's compression ratio on the fly, or changing when the timing at which valves are opened and closed for each individual cycle.

But why would anyone do that? How could it possibly be more efficient to use an internal combustion engine to convert mechanical energy to electricity using a generator, and then transmit that electricity to the car's wheels where a motor converts the electricity back to mechanical energy?

The problem is that that's two conversions, compared to no conversions if the mechanical energy is used, simply and without conversion, to drive the car's wheels. Surely it would be more efficient without converting to electricity and back.

It would seem so, but it is not. An internal combustion engine struggles to deliver power to the wheels of a car over wide variations in the speed of the car and the amount of power required. A typical gasoline car delivers only about 15 to 20% of the energy in a gallon of gasoline to move the wheels of the car.

And that's with a complex gear train and sophisticated engine control perfected over generation after generation of power train and drive train design. At this point, it's hard to wring much more efficiency out of the towel for gasoline engine-powered cars. American carmakers are being forced to by government regulation, but it's a real struggle to do so.

With an adaptive electric power supply and electric motors driving the car's wheels, it may be possible to double those gasoline car efficiency numbers. An Atkinson-cycle, or even a diesel-cycle, engine can be used, with their higher efficiency. A gear train could be foregone. And electric generators and motors can operate at greater than 90% efficiencies.

Technologies like cylinder deactivation, changes in cylinder compression ratios, camless or free valve engines (using electromagnetic, hydraulic, or pneumatic actuators to open and close the valves), coil over plug (COP) and gasoline direct injection (GDI) can also be used to make the engine operation more electronic (operating at very fast speeds) than mechanical. That gives software designers “more knobs to turn” on the engine and allows the engine to be more adaptive to conditions.

Significant technical problems will still remain. After all, physics is still physics. But there will also be many more potential efficiencies to explore. The towel of efficiency gains will no longer be wrung dry, but now sopping with possibilities.

Batteries

Batteries store electrical energy as chemical energy. There are many different types of battery—lead-acid, nickel metal hydride, lithium ion, and others. Each type of battery has its advantages and disadvantages.

Tesla Motors and other companies have improved performance of batteries in cars, mainly by treating each battery cell separately and carefully controlling heat and other factors. But all batteries have problems with energy density (less than 10% that of gasoline), charging and discharging time, and cost.

Supercapacitors

Unlike batteries, which convert electrical energy to chemical energy to store the energy, supercapacitors store electricity as electricity. That makes them more responsive in charging and discharging, which they can do much more quickly than batteries. They also can handle repeated charging and discharging over a useful lifetime of from 10 to 20 years.

On the disadvantage side, supercapacitors can only hold 10% to 20% of the charge that a battery of the same weight can hold. Compared to gasoline, the energy density of supercapacitors is less than 1%. Also, voltage varies according to charge, so storing and recovering energy in a supercapacitor requires sophisticated electronic control and switching equipment. Finally, costs are high.

Regenerative Braking

When a car slows down, its kinetic energy converts into some other form of energy. When friction brakes are used, as in most cars, that energy is wasted as heat. But the kinetic energy (or at least some of it) can be converted to electrical energy and used.

The same motors that power a car's wheels can be used as generators to slow the car down in the right electronic circuitry is used. This is called regenerative braking.

There are other possible electrical energy sources than just the four discussed above, and our adaptive power supply can handle a variety of them. Our adaptive power supply cares only what the energy sources do, not how they do it. That means that an adaptive power supply can appear to the rest of the car as a “black box.” That makes a difference.

For instance, the modular nature of an adaptive power supply may allow a car owner to change his or her sources of electrical power both in the short and the long term. A car owner who normally uses his car for commutes might rent and add a gasoline engine to the adaptive power supply to allow his car to work well on a long vacation drive across the country.

Or a car owner who moves from Fairbanks, Ala. to Honolulu, Hi. might want to buy a new adaptive power supply and sell her old one. That lets her have a car tailored for the typical driving distances, weather and energy sources in Hawaii rather than those in Alaska.

The modular approach brings another big advantage. The power engines in our cars tend to stand unused most of the time. The typical car engine can produce at peak 100 kilowatts of power. That's a big energy converter. Yet the typical car spends over 90% of the time sitting parked and unmoving, with the engine off.

Making an electric power supply largely independent of the rest of the car will open up opportunities to use this powerful energy converter for a variety of uses. An electric power supply that burned gasoline to generate electricity at 35% efficiency, for example, might produce perhaps 100 kilowatts of electricity at about 25 cents a kilowatt hour if gasoline cost $3 a gallon.

That's not bad for portable electrical power, for use during blackouts to power a house, or for construction or farm work where grid electricity is not readily available. Indeed, it would be a throwback to the days when farmers used Ford trucks to power all kinds of machinery by jacking up the rear end and running a belt off a rear wheel.

But the biggest benefit of an adaptive power supply is the power to optimize. By sensing conditions and adapting to them at computer rather than human speed, an adaptive power supply can provide optimal efficiency over the varying conditions that a car encounters day after day and trip after trip.

As technologies improve, that might mean our cars start to see in real life the efficiencies of hundreds of miles to the gallon that only the toy-type cars in supermileage contests see today. That would be a huge boon to the carmaking industry under pressure to deliver something that today is in practice paradoxical—high-performance cars that sip fuel.

How do You Make an Adaptive Power Supply?

### DETAILED EXAMPLES

In these detailed examples, the internal combustion engine (with selective cylinder activation), generator/motor, batteries, supercapacitors, and regenerative braking are discussed largely as “black boxes,” without discussing the details of how they work. That is because these devices are known in the art. They are complex devices in their own right, but most of the details of how they function will not be important to our invention.

The first example below is adaptive to changes in the current demanded from the adaptive power supply, and prevents (as far as possible) those changes from decreasing efficiency. The adaptive power supply in that example adapts the number of cylinders that fire in the internal combustion engine, and the angular speed of the engine, to provide the demanded current and voltage at the highest possible efficiency.

Each example that follows then has varying degrees of the level or sophistication of adaptiveness, usually building on that of the example before.

### Example 1

### Load Following

This example uses relatively passive adaptation. As shown in FIG. 6, the electrical power sources are:
a 70-kilowatt 4-cylinder (each cylinder can be individually fired) internal combustion engine driving a 50-kilowatt permanent magnet brushed direct current generator
a 10 kilowatt hour battery

In addition to the two electrical power sources, as shown in FIG. 6, the adaptive power supply has:
power electronics (which may be transistors like IGBTs or banks of MOSFETs, or motor drivers)
a control system (which may be software running on a microprocessor like a Raspberry Pi)
sensors for current demanded, engine angular speed and cylinder state
actuators for selectively firing the cylinders of the internal combustion engine
a communications network for communicating between the control system, the switches, the sensors, and the actuators

Note that the best results may come from having the control system be largely software-based, running on fairly generic hardware. The software can be upgraded as drivers use the adaptive power supply and experience accumulates. That lets the adaptive power supply become even more adaptive without the car owner needing to buy a new car, or even a new power supply.

The generator can be used as a motor as well, almost instantaneously. That makes it possible to maintain engine rotations at the optimum speed for torque and for voltage.

By choosing whether or not to fire each cylinder each time the cycle allows it to be fired, the torque provided by the engine, and thus the current produced, can be varied on a millisecond (or maybe even microsecond) basis. Doing that means that the generator can follow the load required to provide torque to the drive motors without the about 15% (on average) energy loss when batteries are charged and discharged.

In this example, the adaptive power supply produces power at 50 volts. It monitors the amount of current being drawn, and as the amount of current increases or decreases, decides which power sources to draw on to follow the load being put on the adaptive power supply by the car. This is “load-following” power generation.

The peak current that the adaptive power supply can produce is 1,200 amps. The peak current output of the generator is 1,000 amps (at 50 volts, giving 50 kilowatts peak power output). The peak current of the battery is 1,200 amps.

The key with the generator is the ability to selectively fire each cylinder of the engine powering the generator once every two revolutions. When the engine is turning over at 3,000 revolutions per minute, that means with this 4-cylinder engine there are 100 firing opportunities per second. Or one firing opportunity per 20 milliseconds.

That means that in each second, the torque can be zero (no firings) to maximum (100 firings) or anywhere in between. Since the amount of current the generator generates is proportional to the amount of torque the engine produces, that means that the current generated can also be zero to maximum or anywhere in between.

Unlike a typical engine, which adjusts torque by throttling air, we adjust torque by spreading quantums of torque over time. By “quantum,” we mean the amount of torque that a cylinder produces when it fires. At 3,000 revolutions per minute, that means that one quantum of torque can be added at 20 millisecond intervals.

But that only works if the engine is spinning fast enough to generate 50 volts. In this example, the engine has to be spinning at 3,000 rpm to generate current at 50 volts. So the engine speed must be monitored, and if the engine is not spinning fast enough, it will have to be sped up. There are several ways to speed up the engine, such as:
firing the engine's cylinders to provide torque to spin the engine faster rather than to generate current
applying voltage from the battery to the generator so it functions as a motor, which can be used to spin the engine up to a higher speed through the crankshaft that connects the generator to the engine
decreasing the load on the engine

On the flip side, if the engine is spinning too fast, it will produce too high a peak voltage. So it will need to be slowed down. There are several ways to slow down the engine, such as:
let the engine slow down gradually due to friction and other losses, although that may be slow as it is like coasting to a stop
increasing the electrical load placed across the generator terminals so that more torque is demanded from the engine by the generator (or even apply voltage to create negative torque)
using a mechanical friction brake on the engine crankshaft
if camless engine valve control is available, the engine can be slowed by opening one or more valves on the piston upstroke and closing all valves on the downstroke to create engine braking where the piston has to pump vacuum

Let's trace how the power supply adapts to changes in current drawn. The adaptive power supply has sensors to detect:
how much current is being drawn
the speed of the engine
the state of charge of the battery

If the motor controllers draw more current from the adaptive power supply, the extra current initially comes from the battery.

Then the adaptive power supply adapts. If the generator can produce the needed current more efficiently, if the engine is spinning fast enough, the engine will be told to provide more torque, which can then be converted to more current. If the generator is not spinning fast enough, the engine will still be told to produce more torque to get it up to speed, and the battery will provide current until it gets up to speed.

FIG. 8 shows how this works. As the car starts up from a full stop, the battery provides all power until the generator has spun up to speed, when it starts to provide the full amount of the required current by firing nearly constantly.

As the car reaches 25 miles per hour, less current is needed, so the generator fires less often, charging the battery from time to time as more current is produced momentarily than the car's motors require. As the car begins to slow to a stop, the generator turns off and the battery supplies any required current (the power train will not require current, but other parts of the car might).

Starting from a full stop again requires the same as above, but going up the hill will continue to pull a lot of current, so the generator will stay on. After the hill is crested, the generator will turn off until the car's motors again start to pull current on the flat road.

To determine how many cylinders of the engine must fire each second, the control system of the adaptive power supply must get input from sensors and calculate the number from that. The actual cylinders that are fired, and when, can be adjusted to minimize engine vibration.

Better efficiency may be possible by doing the calculation more frequently, with best efficiency at probably 100 times a second or more. And better efficiency may be possible by using a real-time, sensed number for amps generated per cylinder firing.

When some firing opportunities come around, the cylinder may need to be fired to maintain the engine speed instead of to generate electricity. If no electrical load is put on the generator, the torque from the cylinder firing will increase the speed of the engine.

Alternatively, the battery can be used to provide current to drive the generator as a motor and thus to increase the speed of the engine.

To adapt the power supply to conditions and get the highest efficiency, an efficiency profile for each type of power source can be used. An algorithm then looks at the profiles to decide which of the power sources to use and when.

Pulsating torque or current can be a problem. If, for example, only 4 cylinders fire in 1 second, that might produce 4 short bursts of current every 250 milliseconds, which might not be acceptable as output of the adaptive power supply even though it would average out to the proper amount of current over the full second.

To smooth out the torque over the full second, a flywheel or similar solution can be used on the mechanical side, or a capacitor or similar solution can be used on the electrical side to smooth out the current.

Electrical motors and generators have to deal with ripple currents and torque ripple in any event, so some solution will be needed to filter out the pulses in current in any event. Similarly, internal combustion engines have to deal with pulses in torque during the four-stroke cycle of the cylinders, and even with variations during the power stroke due to firing and gas expansion, and to engine geometry, so a solution can usually be found.

FIG. 7 illustrates a process that the power supply will follow to deliver the desired current using:

(a) an internal combustion engine whose cylinders can be selectively fired, and which is connected to

(b) an electric motor/generator and

(c) a battery.

Generally, the process begins by the controller finding out how much current is being pulled from the power supply. This determination would typically be made by a current sensor as shown in FIG. 6. Note that the controller does not receive any control signal from outside the power supply, such as from a driver of a car pressing on the accelerator pedal. Instead, the power supply operates autonomously, adapting automatically to the amount of current being pulled.

That means that when current is initially pulled from the power supply it is provided by the battery. If the amount of current being pulled from the power supply is greater than the current that would be produced by firing one cylinder, the current is provided by the engine and generator. All of this happens automatically as the power supply adapts to the current being pulled.

To do that, the controller must find out how much current is being produced by the generator. This determination would typically be made by another current sensor as shown in FIG. 6. The controller then determines if the difference in current drawn and current produced by the generator is greater than 1 quantum.

As noted above, by “quantum” we mean the amount of current that would be produced by firing one cylinder in the engine. The amount of torque that the cylinder will produce depends on its displacement, although it will be affected by other conditions as well. The amount of current produced by the generator will depend on the amount of torque being input, so the quantum of current that will be produced by one cylinder can be calculated for the engine and generator being used.

Although this calculation may be for ideal rather than sensed conditions, even if less current is produced than under ideal conditions, the algorithm will still work since the battery will produce any current shortfall.

If the difference in current drawn and current produced by the generator is greater than 1 quantum, then the engine and generator need to produce more current. The voltage at which the generator will produce current depends on the speed at which the generator is rotating. Since the engine and generator shafts are coupled together, they will rotate at the same speed.

If the gasoline engine is already at the speed it needs to be to generate at the required voltage, then the controller will send a signal to fire the next cylinder and will turn the power electronics on so that the current produced by the generator will be output by the power supply. If the gasoline engine is not up to speed, then the controller will send a signal to fire the next cylinder and will turn the power electronics off so that the extra torque will boost the engine speed.

If the generator does not need to produce more current, then the controller will check if the battery needs to be charged.

If it does, the controller checks if the gasoline engine is up to speed. If the gasoline engine is up to speed, then the controller checks to make sure that the battery is not receiving too much current. If it can accept more charging current, then the controller will send a signal to fire the next cylinder and turn the power electronics on to charge the battery.

If the battery does not need to be charged, or if it is already receiving the maximum amount of charging current it can take, then the controller will not fire the cylinder and will turn the power electronics off.

If the battery needs to be charged but the engine is not up to speed, then the controller will send a signal to fire the next cylinder and turn the power electronics off so that the engine speed increases.

The control process shown in FIG. 7 is performed periodically when the power supply is operating. The overall effect of the process is for the engine/generator to follow the current load being placed on the power supply. Since the current produced by the engine/generator is directly used as much as possible, without going into or out of the battery, there are minimal charging/discharging losses and efficiency is high. At the same time, the power supply is able to produce as much current as needed even if the engine/generator is not able to immediately spin up and produce it.

The adaptive nature of the power supply means that no external control is needed and the power supply automatically and autonomously adapts to conditions as they change to maintain the highest possible efficiency.

### Example 1A

### Load Following

This example differs from Example 1 in that the internal combustion engine of Example 1, whose cylinders can be selectively fired, is replaced by:
a 70-kilowatt 4-cylinder (the compression ratio of the cylinders can be varied during operation between 8:1 and 14:1) internal combustion engine driving a 50-kilowatt permanent magnet brushed direct current generator

In this example, the internal combustion engine allows for the compression ratio in its cylinders to be mechanically varied during operation so that the engine can produce more or less torque at greater or lesser efficiency. Varying the compression can usually be done fairly quickly, at half a second or less. By varying the compression ratio as the current demanded of the adaptive power supply varies, efficiency can be optimized as the adaptive power supply adapts to the varying conditions.

The compression ratio of an engine can be varied during operation by changing the length of the piston stroke or by changing the size of the cylinder. Nissan Motor Company provides one example of changing the length of the piston stroke in “Reciprocating engine with a variable compression ratio mechanism,” U.S. Pat. No. 6,920,847. Saab provides one example of changing the size of the cylinder in “Reciprocating piston engine with a varying compression ratio,” U.S. Pat. No. 5,025,757.

The compression ratio of the engine is continually adjusted to provide the optimum value for varying electrical current demands. With a variable compression ratio, the engine can be run at the optimum compression ratio of 14:1 at low load in order to maximize the use of the energy in the fuel. The compression ratio can then be lowered to 8:1 at high load to enable the engine performance to be enhanced by supercharging without inducing “knocking.” And at the expense of some complexity in both hardware and the control algorithm, the compression ratio can be varied between 8:1 and 14:1 to meet partial load conditions.

In either case, the optimum compression ratio is calculated by an engine management system based on the engine's speed, the amount of charge in the battery, and the amount of current demanded of the adaptive power supply. Other factors can also be factored in. In both cases, a supercharger or turbocharger can also be used to increase the volume of air that is in the cylinder before compression, since that means more fuel can be injected and more torque produced.

For highest efficiency, a supercharger or turbocharger should be used at lower compression ratios. A mechanical compressor used for supercharging can be engaged and disengaged by the adaptive power supply control system. The compressor can be equipped with an intercooler. A compressor might be used instead of a turbocharger because today's turbochargers are not able to deliver the high boost pressure and fast response needed by many engines.

The adaptive nature of the power supply means that no external control is needed and the power supply automatically and autonomously adapts to conditions as they change to maintain the highest possible efficiency.

### Example 1B

### Load Following

This example differs from Example 1 in that the internal combustion engine of Example 1, whose cylinders can be selectively fired, is replaced by:
a 70-kilowatt 4-cylinder (the opening and closing of the intake and exhaust valves for each cylinder can be controlled during operation) internal combustion engine driving a 50-kilowatt permanent magnet brushed direct current generator

In this example, the internal combustion engine allows for the opening and closing of the intake and exhaust valves for each cylinder to be mechanically controlled during operation so that the engine can produce more or less torque at greater or lesser efficiency. For example, by varying the time when the intake valves close, a cylinder can be operated in an Atkinson cycle or an Otto cycle. This trade-off between torque and efficiency can be done dynamically for every four-stroke sequence of the cylinder. By varying the timing of intake and exhaust valve opening and closing as the current demanded of the adaptive power supply varies, efficiency can be optimized as the adaptive power supply adapts to the varying conditions.

The adaptive nature of the power supply means that no external control is needed and the power supply automatically and autonomously adapts to conditions as they change to maintain the highest possible efficiency.

### Example 2

### Load Leveling

This example has the same electrical power sources as Example 1 above.

In addition to the adaptation of Example 1, if the battery gets low in charge, the generator will be told to produce more current to charge the battery, instead of or in addition to providing current to move the car forward. This is “load leveling” power generation.

To charge the battery, which in this case produces 50 volts, the generator will need to produce up to about 58 volts. So the gasoline engine will need to spin up to about 3,500 revolutions per minute rather than the 3,000 used to produce 50 volts. The increased speed can be generated by firing more cylinders and generating more torque.

Since a brushed direct current generator is used, the generator may even be hooked up directly to the battery to charge it. If a voltage higher than 50 volts may be harmful if applied to the output of the adaptive power supply, the current to the output may be switched off while the battery is charging.

Example 3

### Load Predicting

This example uses more active adaptation. The electrical power sources are:
a 70-kilowatt 4-cylinder (each cylinder can be individually fired) internal combustion engine driving a 50-kilowatt permanent magnet generator
a 10 kilowatt hour battery
a 0.5 kilowatt hour supercapacitor
up to 60 kilowatt regenerative braking

In this example, the adaptive power supply can produce power at various voltages, with the minimum voltage being 20 volts and the maximum voltage 50 volts. It predicts the amount of current that will be drawn, and as the amount of current increases or decreases, decides which power sources to draw on to follow the load being predicted to be put on the adaptive power supply by the car. This is “load-predicting” power generation.

The peak current that the adaptive power supply can produce is 1,200 amps. The peak current output of the generator is 1,000 amps (at 50 volts, giving 50 kilowatts peak power output). The peak current of the battery is 1,200 amps, that of the supercapacitor is 60 amps, and that of regenerative braking is 1,200 amps.

When a car is being driven over a particular route that the driver has entered on a navigation system, the adaptive power supply can use that information to predict the load that the power supply will need to supply. The more information the adaptive power supply is given, the more predictive it can be.

For example, if a car is going from Lake Tahoe to San Francisco, there will be a net drop in elevation of over 6,000 feet. Regenerative braking may be able to transform a lot of the potential energy of the car that comes from starting at that height into electrical energy that can be stored in the car. The battery on the car should be prepared to accept that electrical energy.

If the adaptive power supply also has detailed, three-dimensional information about the route that includes all slopes and stops, it can be even more predictive and adapt accordingly. Real-time information on traffic conditions received over radio or cell phone will also help.

### Example 4

### Load Management

The example uses even more active adaptation. The electrical power sources are:
a 70-kilowatt 4-cylinder (each cylinder can be individually fired) internal combustion engine driving a 50-kilowatt permanent magnet generator
a 10 kilowatt hour battery
a 0.5 kilowatt hour supercapacitor
up to 60 kilowatt regenerative braking

In this example, the adaptive power supply can produce power at various voltages, with the minimum voltage being 20 volts and the maximum voltage 50 volts. It predicts the amount of current that will be drawn, and also can send signals to the car operating system to reduce current demand until a more efficient power source can be used. This is “load-management” power generation.

The peak current that the adaptive power supply can produce is 1,200 amps. The peak current output of the generator is 1,000 amps (at 50 volts, giving 50 kilowatts peak power output). The peak current of the battery is 1,200 amps, that of the supercapacitor is 60 amps, and that of regenerative braking is 1,200 amps.

Instead of producing peak current as demanded, the adaptive power supply will request that partial power be accepted, and will inform the car operating system when full power will be available. When the load is managed to briefly constrain the amount of provided power to enhance efficiency, this is called “load management”.

### Example 5

The adaptive power supply can adapt to a different motor controller or motor module being installed. The power supply control system can be set up with different configurations depending on the motor controller or motor module connected to the power supply. The power supply can then sense what motor controller or motor module is now connected, and use the configuration for that controller or module to adapt to the change without the need for the driver of the car to do anything.

### Example 6

The adaptive power supply can adapt to different energy sources being installed. For example, if a battery goes dead, a battery with different characteristics could be installed to replace it. The power supply control system can be set up with different configurations depending on the battery that is part of the power supply. The power supply can then sense what battery is now connected, and use the configuration for that battery to adapt to battery change without the need for the driver of the car to make any changes to it.

### Example 7

The adaptive power supply can get electrical current from an outside source, or send it to an outside source, while traveling or stationary.

While traveling, the power supply could get or send electrical current using a wireless transfer method, such as an inductive coupler. For example, a car going up a hill might get power from a power cable buried under the road through an inductive charger, and then when going down the hill might return power to a cable in the same way.

While stationary, the adaptive power supply could get or send electrical current using a wireless transfer method or a wired connection. For example, the power supply might take over the charging duties automatically, so as to have power available for a planned trip. Or the power supply might send electrical current off the car to get rid of excess charge or to provide power for some off-car purpose.

### Example 8

The adaptive power supply can learn from the driving experience of the car to become more adaptive to conditions, or can obtain information about a planned route to be able to adapt in advance. Tie-ins with route maps and global positioning satellite information may also help.

For example, the power supply control system can be beefed up to be able to sense driver behavior during travel, and to store those conditions so that it can adapt itself better during later travel.

Or the power supply control system can store conditions over a particular route, so that it can adapt itself in advance to things like hills or stops that will require more electricity or will result in electricity being generated.

### Example 9

The adaptive power supply can be designed to work with a particular motor or set of motors to deliver the required voltage and current without needing power electronics to drive the motor. For example, the speed of the motor can be increased to provide higher voltage, and the torque to provide higher current. This can even be done on a phase-by-phase basis, so that a particular phase of the generator can be coupled to a particular phase of the motor.

### Example 10

The adaptive power supply can include a turbocharger that generates electricity from exhaust gases and in which the generator can also be used as an electric motor to spin up the turbocharger when needed. This is another “knob to turn” where the power supply control system can speed up the motor using electricity rather than gasoline.

### Example 11

The adaptive power supply includes a step-up, step-down transformer to control the voltage put out by the battery. This will make the adaptive power supply able to produce a range of voltages from the battery and spin up the gasoline engine to various speeds to match that range of voltages.

That will enable the adaptive power supply to provide voltage and current at different levels to power different devices. For example, an adaptive power supply may be used in a car to produce 48 volts to power the car, and then be plugged into a house to provide 110 volts to power the house.

The above Examples 1 to 11 are just some examples of our invention. Other components may be used, such as substituting a brushless generator for the brushed generator described. Those skilled in the art will know how to do that. Many other ways of implementing our invention will also work.

In addition, though the examples refer to use of the adaptive power supply in cars, our invention can be used in other applications as well.

### DRAWINGS

FIG. 1 shows a (humorous) prior art example of how an electric car can get electricity on board.

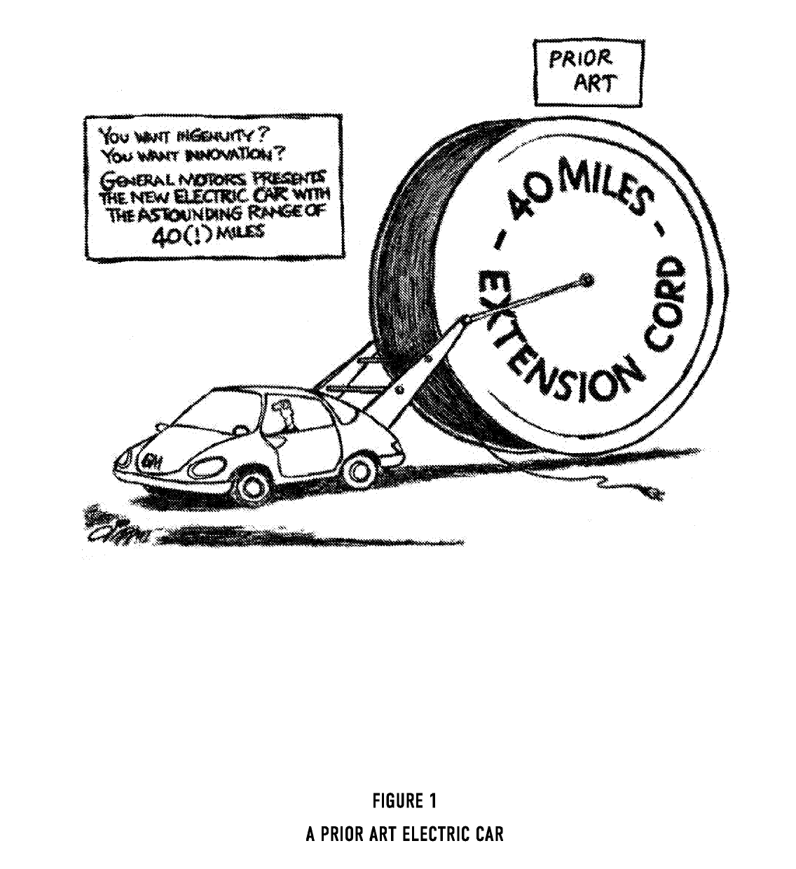

FIG. 2 shows a variety of sources of electricity to power an electric car.

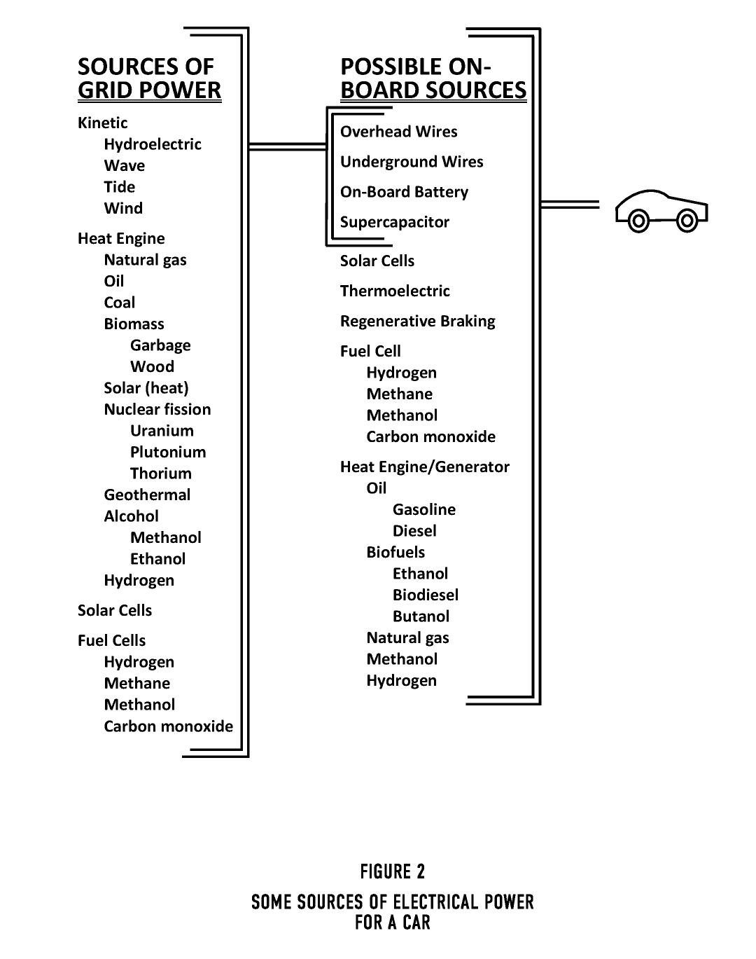

FIGS. 3A and 3B show how power can be transformed by both mechanical (FIG. 3A) and electrical (FIG. 3B) means.

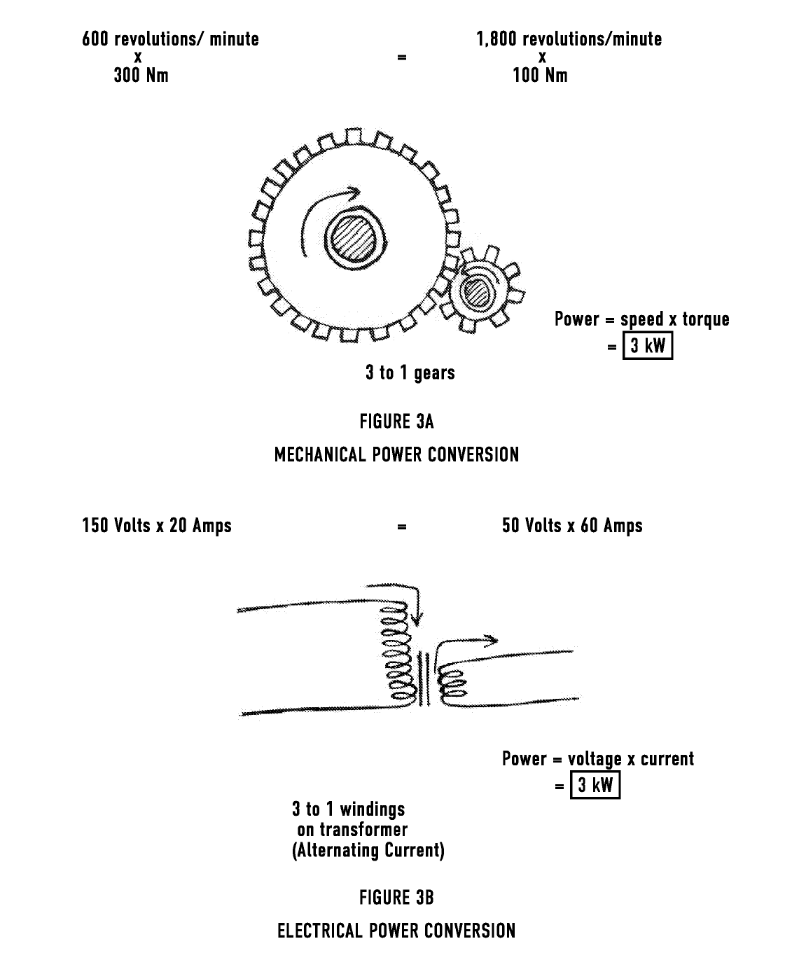

FIG. 4 shows a block diagram how a motor/generator can convert between mechanical and electrical power.

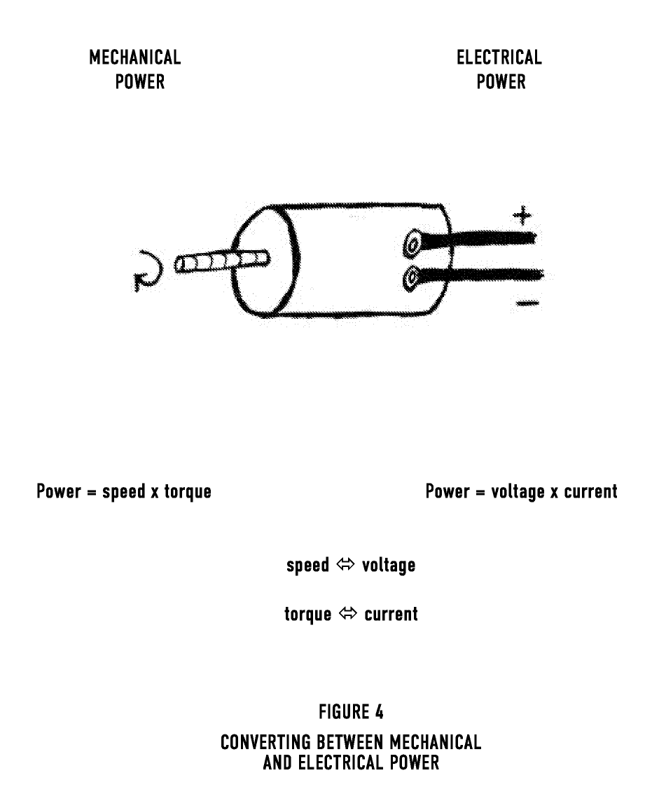

FIG. 5 shows a block diagram of how one example of an adaptive power supply can process information from sources like sensors to decide what sources of electricity it will use to provide the needed electricity with the best performance at each moment.

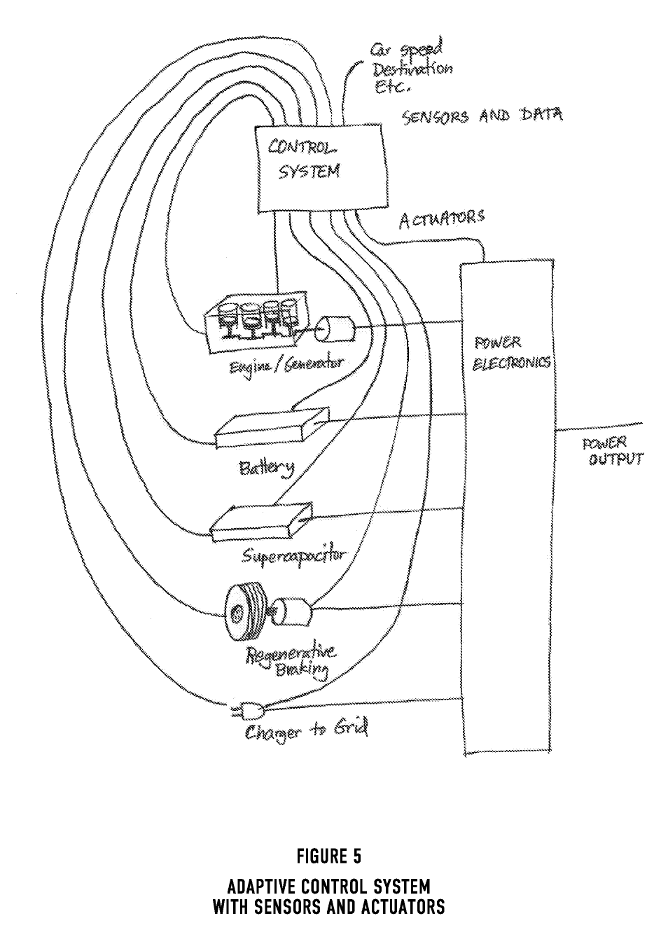

FIG. 6 shows one example of an adaptive power supply with two electrical power sources.

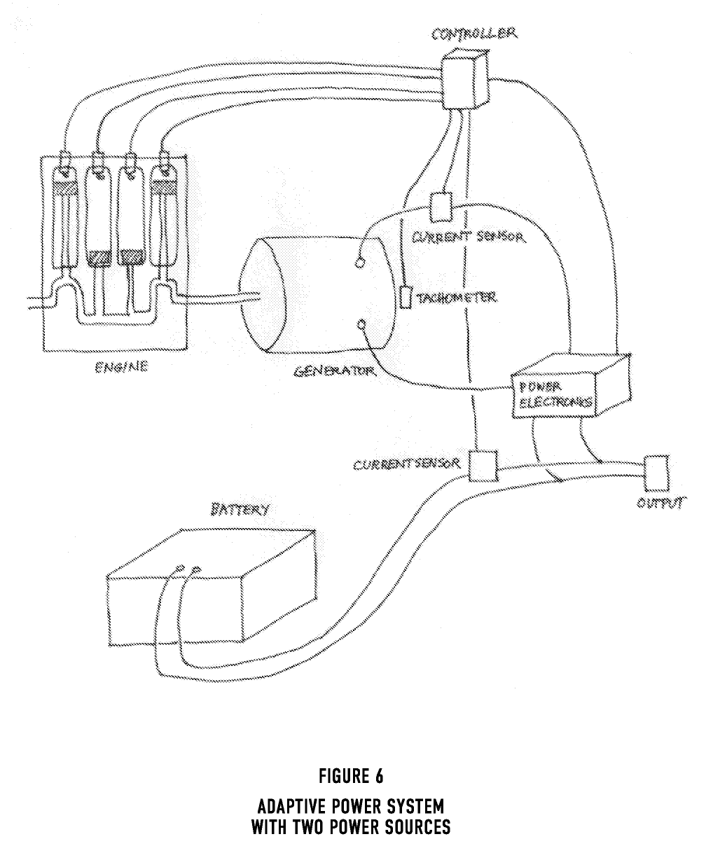

FIG. 7 shows one example of an algorithm used by an adaptive power supply to control two sources of electricity.

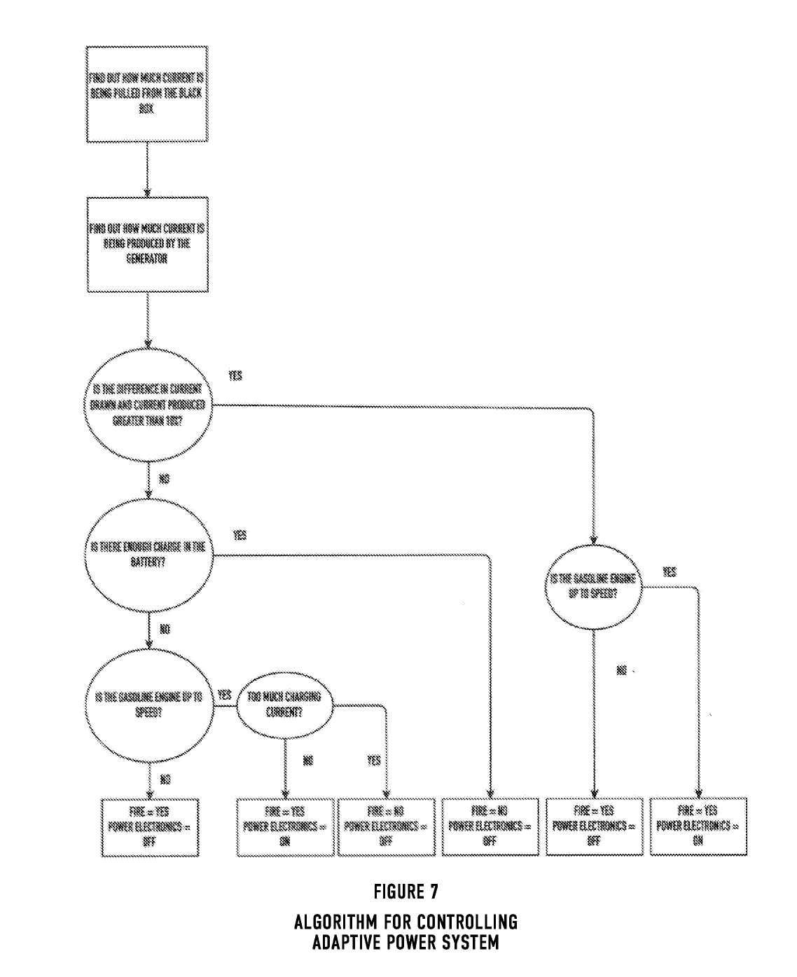

FIG. 8 shows an examples of how an engine/generator and a battery can be adaptively selected between using a “load following” scheme to provide the current needed to drive a car over an example course.

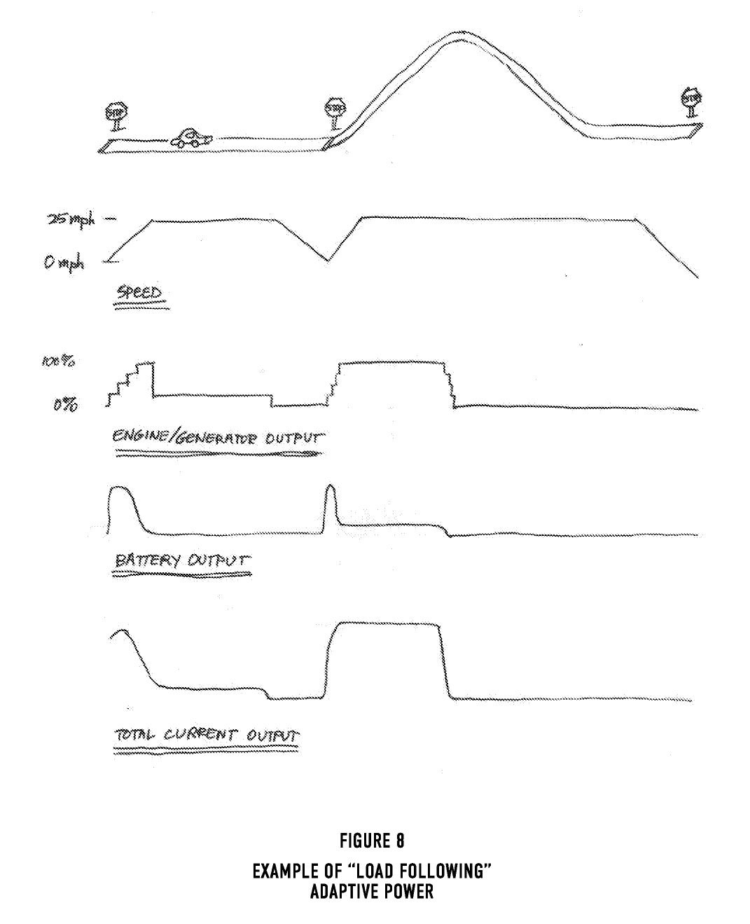

We claim:

1. A power supply that produces only electrical power and supplies that electrical power at a desired voltage and current that may change over time, where the power supply includes at least:
two or more electrical power sources,
an actuator that can change at least one operating parameter in at least one of the electrical power sources,
a sensor that can sense at least one operating condition related to the power supply, and
a controller that includes computer hardware and software and that produces the electrical power at the desired voltage and current by using the actuator to adapting the power supply to the at least one operating condition as the at least one operating condition changes over time.

2. The power supply of claim 1 where at least one of the electrical power sources is a generator powered by an internal combustion engine with at least one cylinder that can be selectively fired.

3. The power supply of claim 1 where at least one of the electrical power sources is a generator powered by an internal combustion engine with at least one cylinder with a variable combustion ratio.

4. The power supply of claim 1 where at least one of the electrical power sources is a battery.

5. The power supply of claim 1 where at least one of the electrical power sources is a supercapacitor.

6. The power supply of claim 1 where at least one of the electrical power sources is regenerative braking of an electric car.

7. The power supply of claim 2 where the internal combustion engine has a combustion cycle that can be varied during operation.

8. The power supply of claim 7 where the combustion cycle can be varied during operation by varying the timing of the opening and closing of intake or exhaust valves.

9. The power supply of claim 2 where the internal combustion engine has a forced induction system that can dynamically vary the pressure of the air entering the cylinders of the engine.

10. A power supply that produces only electrical power, that includes at least two different electrical power sources and that produces the electrical power at a desired voltage and current by adapting to at least one condition that may change over time,
where at least one of the electrical power sources is a generator powered by an internal combustion engine, and
where the speed of the internal combustion engine is regulated to produce the desired voltage and the torque is regulated to produce the desired current.

11. The power supply of claim 10 where the internal combustion engine has at least one cylinder that can be selectively fired.

12. The power supply of claim 10 where the internal combustion engine has at least one cylinder with a variable combustion ratio.

13. A controller for a power supply that produces only electrical power and that controls at least two different electrical power sources to produce the electrical power at a desired voltage and current,
where the controller adapts to at least one condition that may change over time,
where at least one of the electrical power sources is a generator powered by an internal combustion engine,
where the internal combustion engine has at least one cylinder that can be selectively fired, and
where the speed and torque of the internal combustion engine are regulated to produce the desired voltage and current.

14. The power supply of claim 1 where the power supply is a load-following power supply which senses the amount of the electrical load and changes the voltage and/or current produced by at least one of the electrical power sources in order to follow the electrical load as the electrical load changes.

15. The power supply of claim 1 where at least one of the electrical power sources is a generator powered by an internal combustion engine.
